(19) United States
(12) Patent Application Publication
(10) Pub. No.: US 2006/0122891 A1
(43) Pub. Date: Jun. 8, 2006

(54) Method and apparatus of obtaining renovation cost estimates

(75) Inventor: Robert Mario Insenga, Alpharatta, GA (US)

Correspondence Address: NIXON & VANDERHYE, PC, 901 NORTH GLEBE ROAD, 11TH FLOOR, ARLINGTON, VA, 22203, US

(73) Assignee: The Refinishing Touch, Inc., Alpharetta, GA (US)

(21) Appl. No.: 11/002,637

(22) Filed: Dec. 3, 2004

(51) Int. Cl. G06Q 30/00

(52) U.S. Cl. 705/26; 705/28

(57) ABSTRACT

A method of generating online a furniture renovation cost estimate for a customer company having an inventory of wood and/or fabric-covered furniture includes (a) establishing a website enabling users to access a data base storing information relating to furniture types, a range of furniture items within the furniture types; and (b) providing program selection means for enabling users to select a renovation activity for at least one of the furniture items corresponding substantially to a real furniture item of the customer company, and for enabling the user to obtain a cost estimate for the renovation activity.

### BACKGROUND OF THE INVENTION

This invention relates generally to the establishment of a centralized furniture renovation management program and, more particularly, to a supporting pricing guide for estimating costs associated with the program.

Typically, any fairly large business entity (hereinafter, “the company”) owns a correspondingly large inventory of furniture of all types, including wood frame and upholstered office furniture. This furniture supports both living (for example, in a kitchen and/or recreational area) and working environments for the entire work force of the company, and represents a very significant, but largely undocumented, capital investment. The total service life for much of the furniture inventory can exceed 20 years if properly and periodically maintained. Moreover, furniture is a principal factor in the actual and perceived quality of life for the company employees.

Historically, the current condition of the furniture inventory or the costs to maintain or replace that inventory has not been known because there has been no requirement to specifically manage furniture as an asset at the corporate level. Maintenance or replacement of office furniture is typically accomplished with operations and maintenance funds and competes poorly with all other claimants for these funds. Oftentimes, no funds are budgeted or programmed to support maintenance or replacement. As a result, much of the furniture has been in use for 10-20 years without regular care or maintenance and is acknowledged to be in an unsatisfactory state of repair. However, because of the lack of definitive information about the inventory, it has been difficult to develop realistic funding requirements for maintenance or replacement.

More recently, commercial on-site furniture renovation has been widely used, for example, by large and small hotels and universities as a cost effective method to: (1) maintain the value of the furniture investment and (2) insure a high level of quality of service for customers and students.

Hotels, universities and the like cannot be out of service for any period of time, however, and as a result, on-site renovation capabilities and methods have been developed to support their requirements without interrupting ongoing activities or closing down a facility for more than several hours or a few days. The assignee of this invention has developed a furniture management program for use by any type of business entity but that is perhaps most useful to large entities that typically have large furniture inventories, for example, government installations (civilian and military), corporations, hospitals, hotels, and the like. This program provides a process for instituting long-term maintenance and renovation of furniture while reducing personnel costs.

The purpose of the program is to retain both monetary and quality-of-life value of the furniture assets through the use of commercial furniture renovation, using modern techniques and methods that are environmentally safe and highly cost effective. To this end, renovation is incorporated into a furniture renovation management program that leverages economies of scale and permits long term projection for funds and project scheduling on one or more installations in a command area or region. The program consists of a combination of management personnel, renovation craftsmen, commercial hardware/software, and management techniques and procedures specifically designed to support the area installations. Procedures to implement the current program include:

1) On-site inventory and documentation of all wooden and upholstered furniture using standard commercial inventory hardware, software, and procedures. (Modular furniture is not currently included in this management plan because completely different renovation processes are required. However, all other documentation can be used if it is included).

2) Periodic minor maintenance scheduled by the company and executed by trained company technicians in response to customer requests.

3) Long term on-site scheduled renovation using inventory condition data and executed by appropriate number of trained company technicians; and

4) Budget and program development requirements using standard commercial techniques and methods.

In accordance with the technical aspects of commercial on-site renovation, and specifically wood refinishing, waterborne refinishing technology is utilized that poses no danger or discomfort to humans in the immediate vicinity of the work area, and that requires no special personnel, environmental, or fire hazard protection. Finish removal, when required, is done mechanically with complete containment of all dust and residue. Upholstery renovation is accomplished by preparing patterns from the actual project furniture, cutting all of the fabric at the home factory, and then shipping the finished covers to the work site where the crew replaces the old material with new. Upholstery and refinishing in the same area is coordinated by a project manager as a single project. All work can be accomplished on-site, thereby eliminating transportation costs and permitting very short turnaround times for project completion. For example, the standard method for hotel room renovation permits a hotel to turn over 10 to 15 rooms to the renovation crew at the beginning of the work day. The crew refinishes and reupholsters all of the furniture in the rooms and turns them back to the hotel at the end of that same work day. This furniture renovation capability is fully operational in the commercial sector and can be used by (but not limited to), any medical, government, academic, ecclesiastical or corporate installation without modification.

There remains a need to further facilitate the implementation of the current program by adding a user-friendly mechanism, e.g., an internet website, for enabling the user to obtain accurate cost estimates for specific renovation choices appropriate to the company business.

### BRIEF DESCRIPTION OF THE INVENTION

The present invention further refines the existing furniture asset management program to include a user-friendly, internet-available, pricing guide to enable a customer (or user) to make specific renovation choices appropriate to the company's business, and to obtain realistic cost estimates for ongoing implementation of the furniture refinishing program. There is also a need for enabling a customer or potential customer to instantly compare estimated savings realized via a renovation program as opposed to a replacement program.

In the exemplary embodiment, after logging on and registering to set up an account, the user can initially choose from a variety of commercial institutional business categories such as, for example, hospitality (hotels, hospitals, etc.), university (junior colleges, colleges and universities), ecclesiastical (churches, synagogues, etc.) or government (civilian agencies, military installations, etc.) and the like. The user can then choose specific items for renovation from a group of furniture items typically associated with that business category. Having selected a particular item, e.g., a desk and/or an upholstered chair, the user can then identify the size (or approximation thereof) and number of units to be refinished and/or reupholstered. Where reupholstering is part of the refinishing program, the user may also choose from of a variety of available fabrics, categorized according to a conventional grade system (i.e., grade A, B or C). Having made the necessary selections, the user then receives an estimated cost figure that is compared to a furniture replacement alternative, enabling the user to also view an estimated cost savings realized through furniture renewal as opposed to furniture replacement.

This new refinement to the existing furniture asset management program is achieved with the use of one or more microprocessors loaded with appropriate software. The software program itself is considered to be within the skill of the art, especially when guided by the program details provided herein.

Accordingly, in one aspect, the invention relates to a method of generating online a furniture renovation cost estimate for a customer company having an inventory of wood and/or fabric-covered furniture comprising (a) establishing a website enabling users to access a data base storing information relating to furniture types, and a range of furniture items within the furniture types; and (b) providing program selection means for enabling users to select a renovation activity for at least one of the furniture items corresponding substantially to a real furniture item of the customer company, and for enabling the users to obtain a cost estimate for the renovation activity.

In another aspect, the invention relates to a method of obtaining a cost estimate for furniture renovation online by a user with access to a terminal including a computer, a monitor and a keyboard comprising (a) logging on to the website; (b) choosing a business category that most nearly reflects the user's business; (c) choosing a furniture item type from among several furniture types; (d) selecting a volume pricing factor; and (e) choosing to see a cost estimate quote displayed for selected renovation activity.

In still another aspect, the invention relates to apparatus for generating online a furniture renovation cost estimate for a customer having an inventory of wood and/or fabric-covered furniture comprising (a) means for establishing a website enabling the customer to access a data base storing information relating to furniture types, a range of furniture items within the furniture types and estimated costs for renovation activities associated with the furniture items; and (b) means for enabling the customer to select a renovation activity for at least one of the furniture items corresponding substantially to a real furniture item of the customer company, and for enabling the customer to obtain a cost estimate for the renovation activity.

The invention will now be described in connection with the drawings identified below.

### BRIEF DESCRIPTION OF THE DRAWINGS

FIG. 1 is a schematic diagram illustrating generally a method of obtaining furniture renovation cost estimates in accordance with an exemplary embodiment of the invention;

FIG. 2 is a block diagram illustrating the method of obtaining renovation cost estimates in more detail;

FIG. 3 is a representation of a computer screen incorporated as part of the program, and enabling the user to select an appropriate market category;

FIG. 4 is a second computer screen enabling a user to select a particular kind of furniture for renovation;

FIG. 5 is a third computer screen indicating a product description and dimensions for an item of furniture selected from the screen in FIG. 4;

FIG. 6 is a fourth computer screen enabling the user to select a refinishing price as a function of the number of items to be renovated;

FIG. 7 is a fifth computer screen enabling the user to input the quantity of the items selected for refinishing;

FIG. 8 is a sixth computer screen enabling the user to confirm the pricing and add the individual item cost to a total cost estimate;

FIG. 9 is a seventh computer screen providing a cost estimate for selected renovation activity along with an estimate cost-benefit analysis;

FIG. 10 is an eighth computer screen enabling the user to select a particular chair requiring reupholstering for inclusion in the cost estimate;

FIG. 11 is a ninth computer screen enabling the user to confirm the item selected for reupholstering and to choose a refinish pricing based on the number of units are items to be renovated;

FIG. 12 is a tenth computer screen enabling the user to input the number of selected items to be refinished;

FIG. 13 is an eleventh computer screen enabling the user to select from a number of fabric grades for reupholstering the items selected for renovation;

FIG. 14 is a twelfth computer screen enabling the user to select a particular style fabric within the selected grade;

FIG. 15 is a thirteenth computer screen enabling the user to select a particular color for the selected fabric style and grade;

FIG. 16 is a fourteenth computer screen enabling the user to obtain a price quote, but also to add an optional foam component to the item to be reupholstered;

FIG. 17 is a fifteenth computer screen enabling the user to confirm the price estimate and to add the item total to the renovation program total quote; and

FIG. 18 is a sixteenth computer screen indicating the individual and total cost estimates along with an estimated cost benefit analysis.

### DETAILED DESCRIPTION OF THE INVENTION

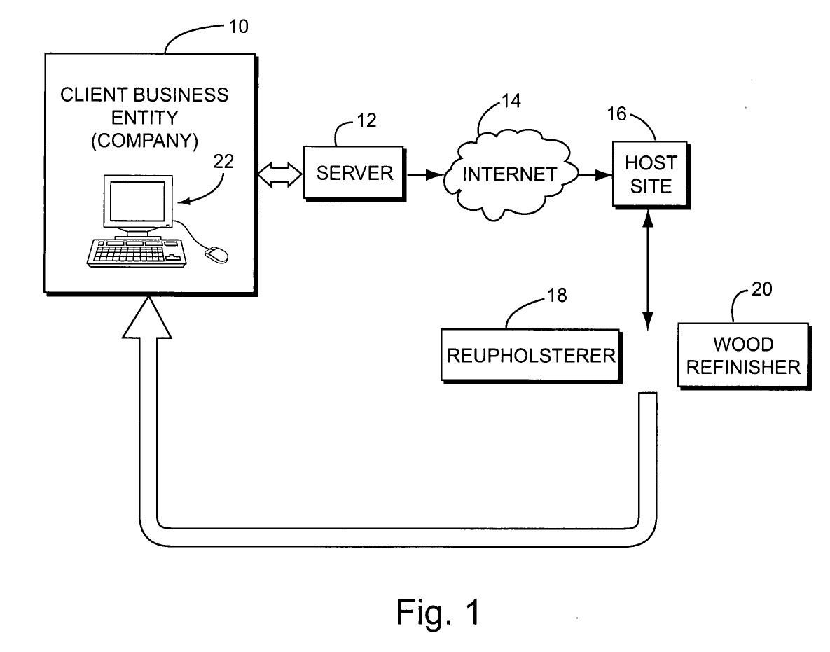

FIG. 1 is a schematic diagram illustrating, generally, a web-based pricing guide system in accordance with an exemplary embodiment of the invention. The client commercial entity (the company) 10 and remote server 12 operate via a communications network such as a land-based telephone network, or preferably, the Internet 14 to access the host site 16. The host site 16, in this instance, is the furniture renovation provider that has its own server (not shown) that is in turn, linked to servers (not shown) at a reupholstering facility 18 and wood finishing facility 20 that may or may not be in the same location. With particularized renovation information in hand, the appropriate reupholstering and/or wood refinishing services are delivered on site to the company.

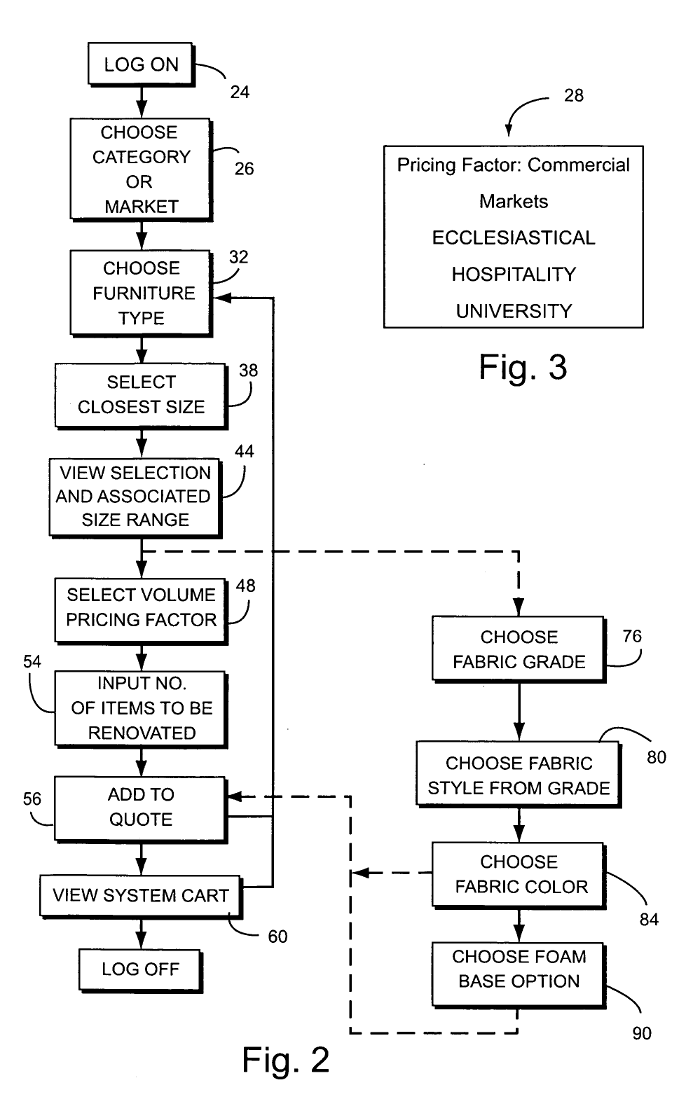

It will be appreciated that the company (user) interface 22 may include one or more terminals in the form of, for example, personal computers such as a Microsoft Windows-based PC having a local hard drive, microprocessor and resident memory. Other suitable terminals, including hand-held computers with other operating systems may also be employed. The company 10 will connect to the Internet 14 via an Internet service provider or any other available network interface links as will be well understood by those skilled in the art. Thus, in the exemplary embodiment, the renovation selection and supporting pricing guide is available to the company 10 at an Internet website via the company interface or PC 22. FIG. 2 illustrates in block-diagram form, a generalized procedure or process that the user will employ to receive an estimated cost or quote for selected renovation work. The individual blocks correspond generally to the corresponding screen displays shown in FIGS. 3-18.

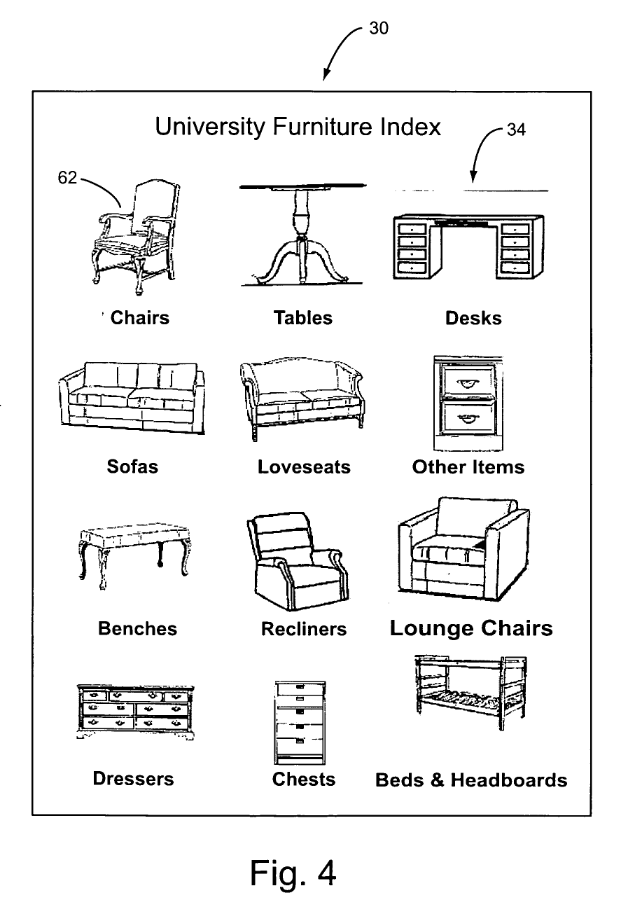

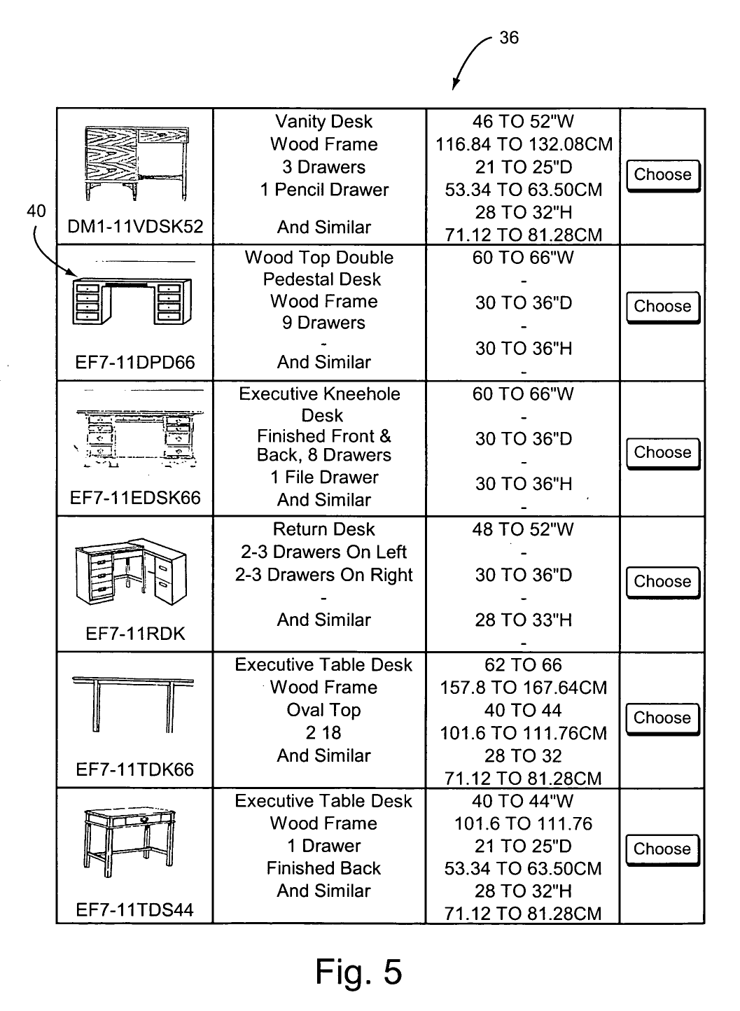

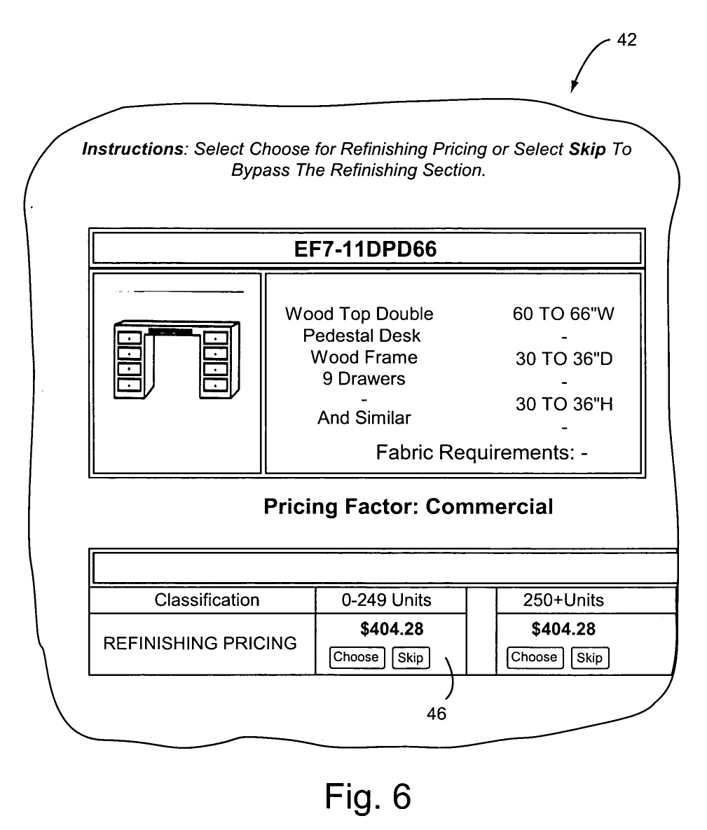

The company user (or simply, “user”), utilizing the PC 22, will log onto the provider or host website (block 24) and register to set up a personalized account in a known manner. Upon logging in, the user will see on the PC monitor the screen 28 illustrated in FIG. 3 and corresponding to block 26. Here, the user will first click on the specific market appropriate to his/her business. Three markets, ecclesiastical, hospitality and university are shown, but it will be understood that other appropriate markets may be included as well. For purposes of this application, we will assume that the user selects the “university” market which will bring the user to a second screen 30 illustrated in FIG. 4, corresponding to block 32. From the available selections within a University Furniture Index, (the selections have been limited for the sake of brevity in this application), and for this example, the user selects “desks” 34 and is brought to the screen 36 in FIG. 5, corresponding to block 38 in FIG. 2, where the user will then choose from a variety of desk styles. The user will select the desk that most closely resembles the desk that is to be renovated and for this example, the user will select desk 40 (Model No. EF7-11DPD66), and will then be presented with the screen 42 illustrated in FIG. 6, corresponding to block 44 in FIG. 2.

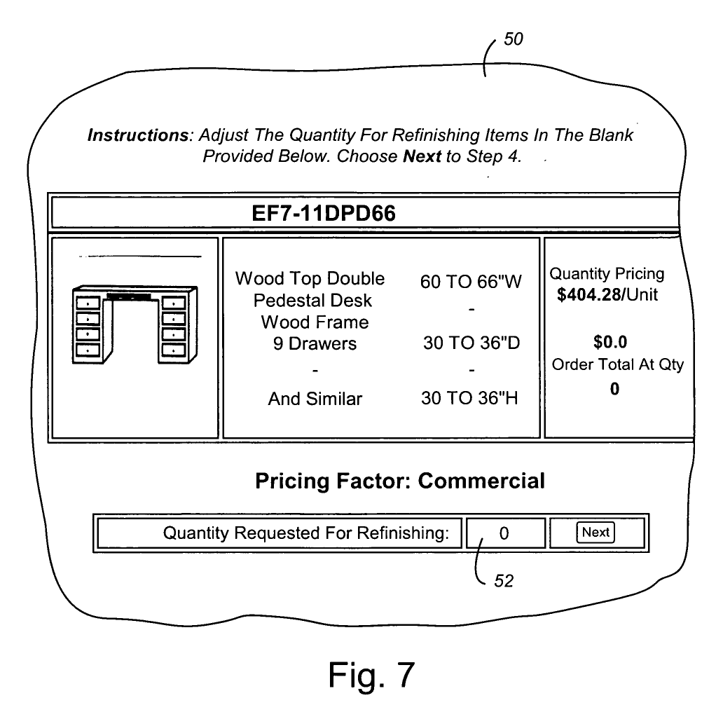

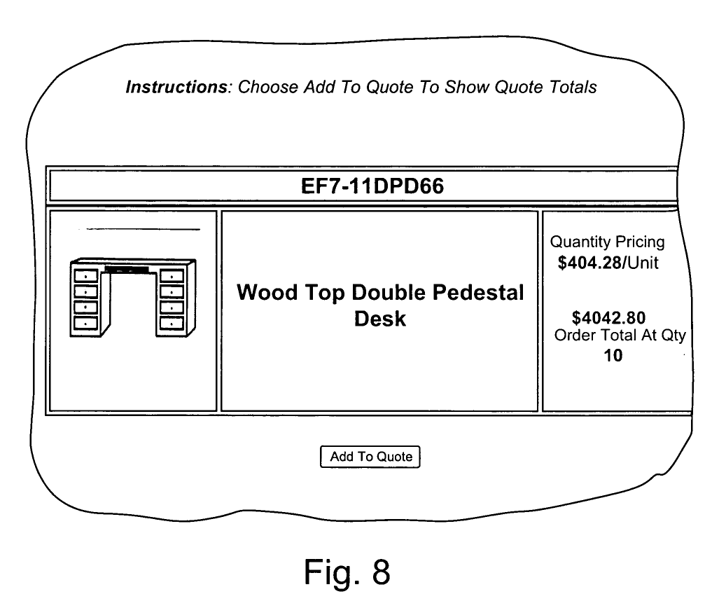

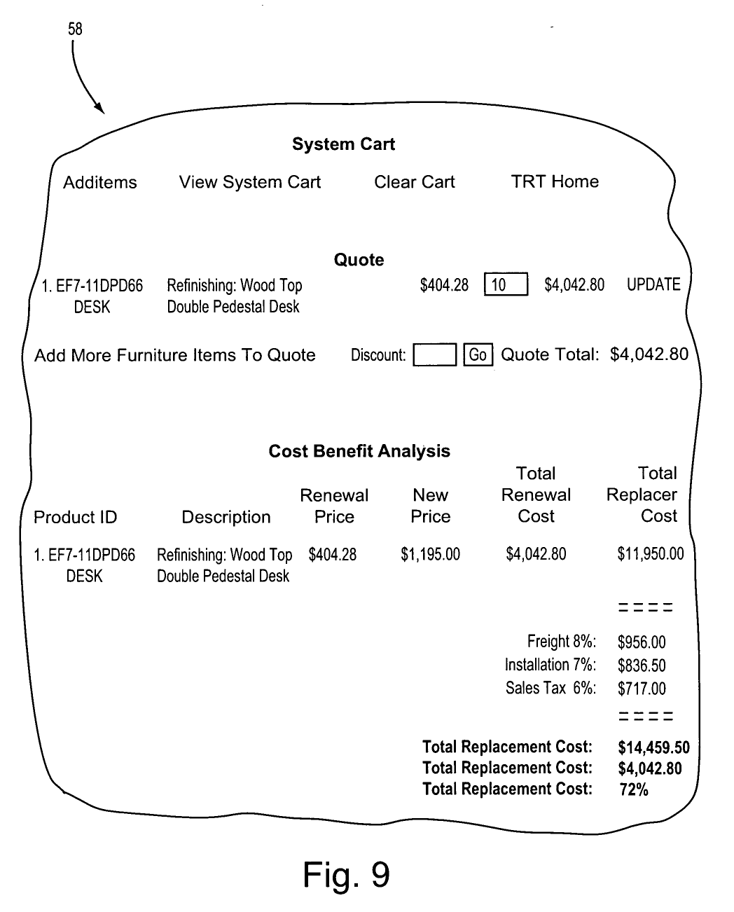

Since there is no upholstery connected with the renovation of this piece of furniture, the renovation will be assumed to involve wood refinishing only. The screen in FIG. 6 illustrates the selected item advises the user of the general range of dimensions for which the indicated price applies, and the user will select a projected pricing factor based on the number of units to be renovated (if the piece to be renovated requires only reupholstering, the user simply selects “skip” to bypass the refinish pricing chart). For purposes of this example, the user chooses the price for 0-249 units in box 46, corresponding to block 48 in FIG. 2, and is then presented with the screen 50 shown in FIG. 7 where the user inputs in box 52 the exact number (10 in the example) of desks to be refinished (corresponding to block 54 in FIG. 2) and then clicks on the “next” button. The screen illustrated in FIG. 8 confirms the quantity pricing unit and the total for 10 desks. The user moves to the next step in the process by clicking the “Add to Quote” button, corresponding to block 56 in FIG. 2. The user is then presented with screen 58 shown in FIG. 9 and corresponding to block 60 in FIG. 2. Here, the user sees the total estimate for the selected renovation work, along with a cost benefit analysis, comparing the estimated total renovation cost to an estimated replacement cost for a similar new desk. The user now also has the option to add additional furniture items to the quote.

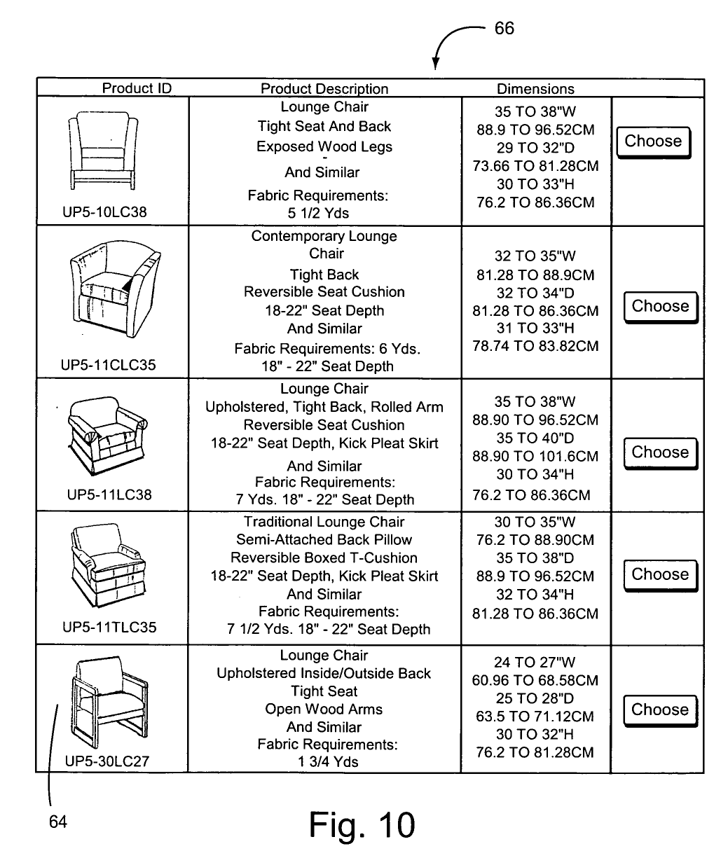

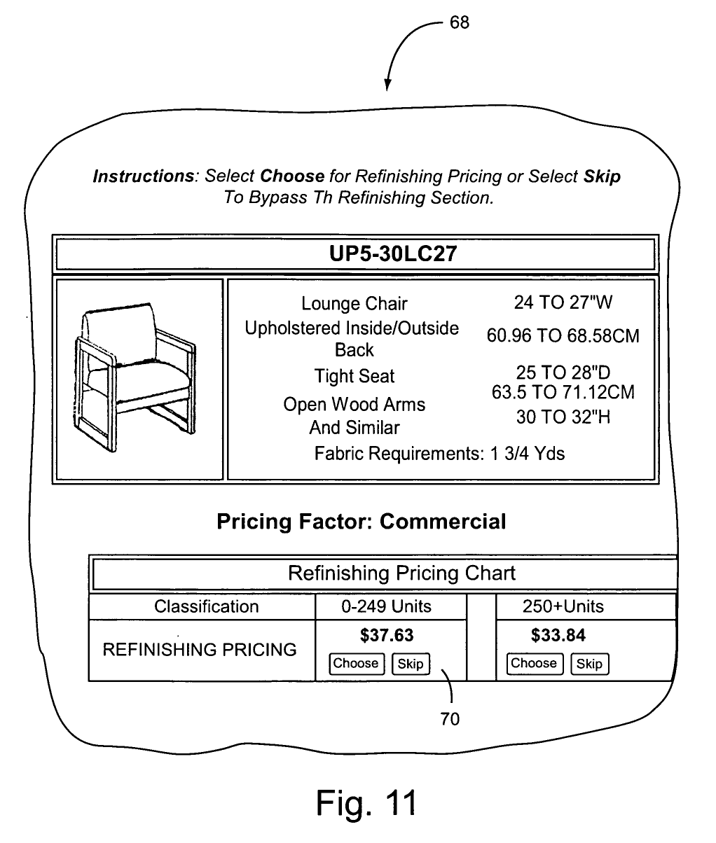

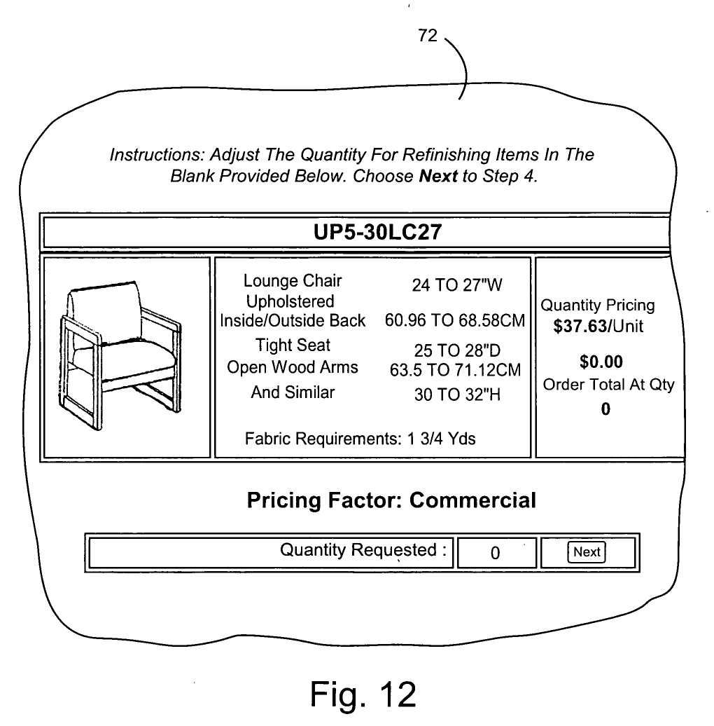

For purposes of disclosing additional features of the pricing guide program, we will assume the user desires to also renovate an item of furniture, i.e., a chair, that requires both refinishing and reupholstering. The user simply returns to the university furniture index screen shown in FIG. 4 and chooses “Chairs” 62. For purposes of this example, the user will choose from screen 66 in FIG. 10 a lounge chair 64 (designated Model No. UP5-30LC27). The user will then be presented with the screen 68 shown in FIG. 11. After confirming that the selected chair is similar in terms of style and dimensions, the user will select a commercial refinish pricing factor consistent with the number of chairs to be renovated. Here, the user will click on “choose” in the pricing chart box 70 for between 0 and 249 units. The user will then be presented with the screen 72 illustrated in FIG. 12, where the price per unit is demonstrated and where the user can add the quantity of chairs to be refinished, and then click on the “next” button. These steps correspond to blocks 32, 38, 44 and 48 in FIG. 2.

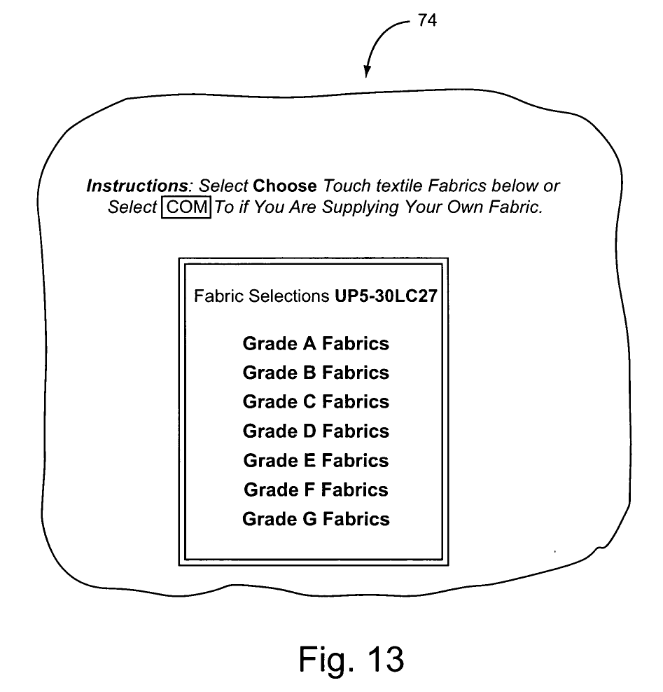

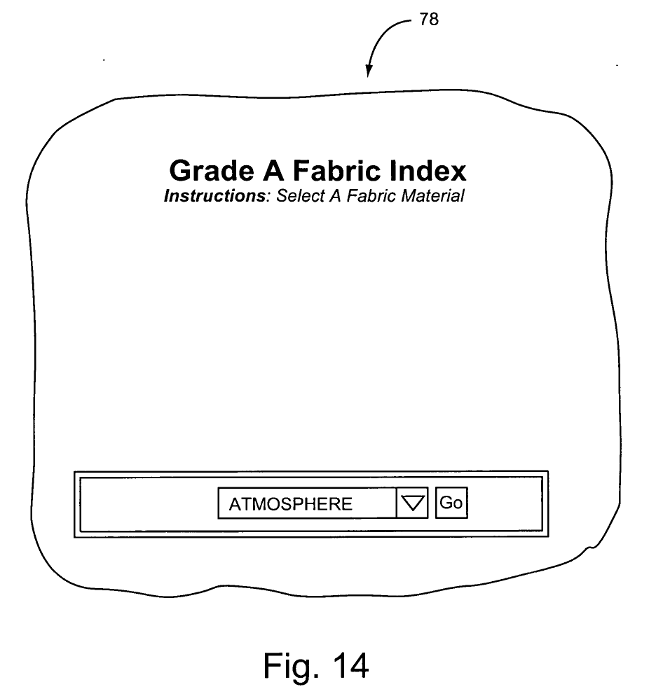

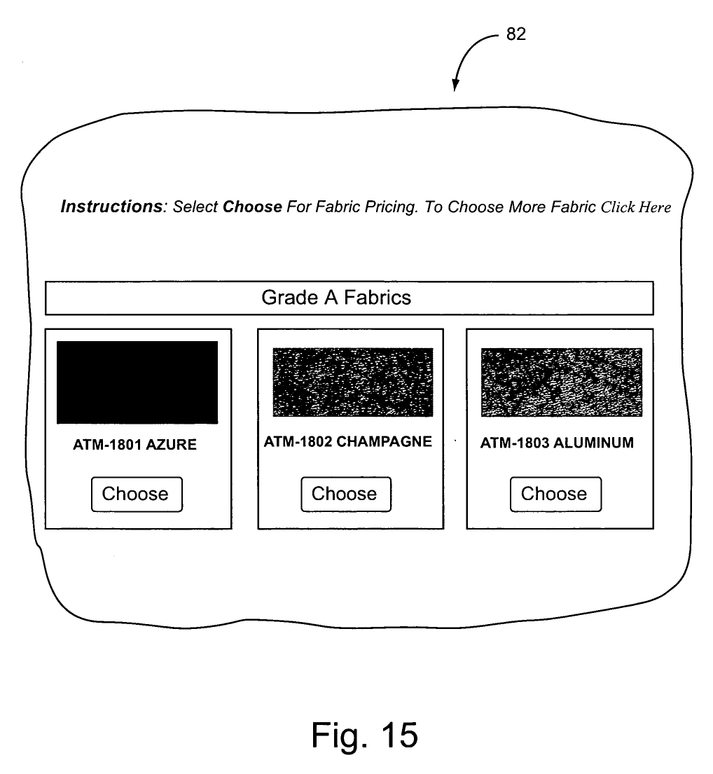

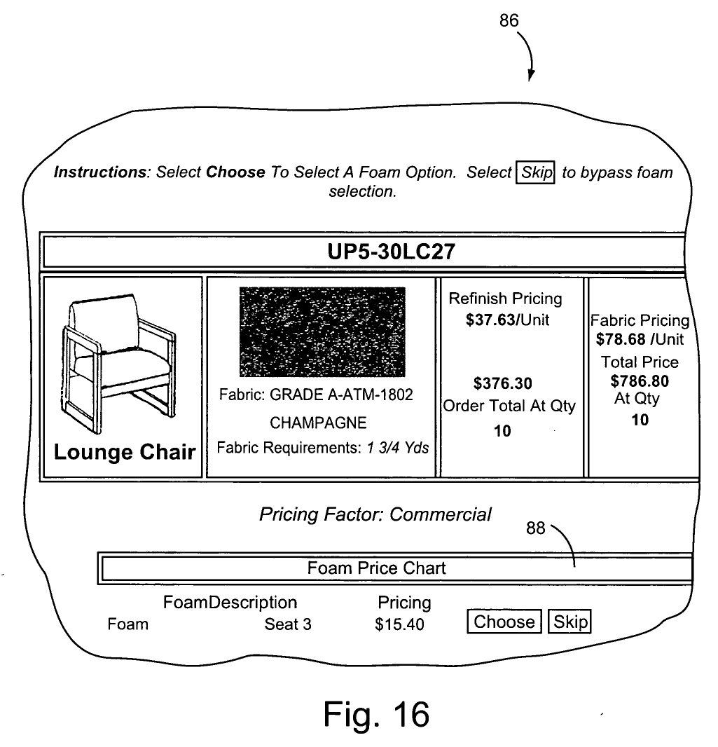

Because the selected chair also requires reupholstering, the user will be presented with the screen 74 shown in FIG. 13 from which the user may select a particular grade of fabric (typical fabric grades A through G are shown but additional grades may be included). Assuming a selection of Grade A Fabrics” in the example given, the user is then presented with a screen 78 shown in FIG. 14, corresponding to block 80 in FIG. 2. By clicking on a drop-down menu, the user will be able to choose from a variety of Grade A Fabrics. Assuming the user clicks on the “Atmosphere” group of Grade A Fabrics, the user is then presented with screen 82 as shown in FIG. 15, corresponding to block 84 in FIG. 2, where various colors of that particular fabric are available for selection. Assuming the user clicks on “ATM-1802 Champagne,” the next screen 86 shown in FIG. 16 will confirm the fabric selection and will display the refinishing price per unit as well as the order total for the specified quantity. Since both wood refinishing and upholstering are involved in the renovation of this particular chair, both the refinish pricing and the fabric pricing will be displayed as is the case in FIG. 16.

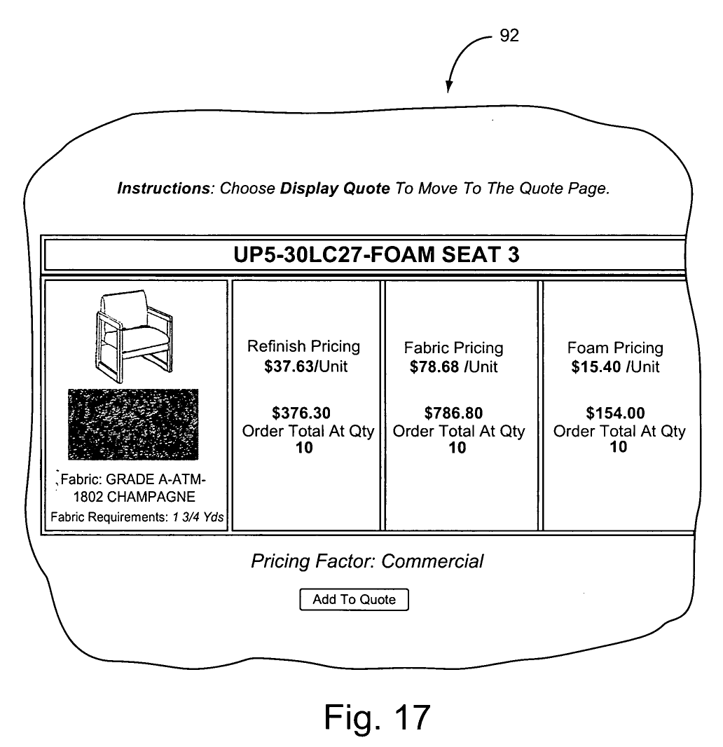

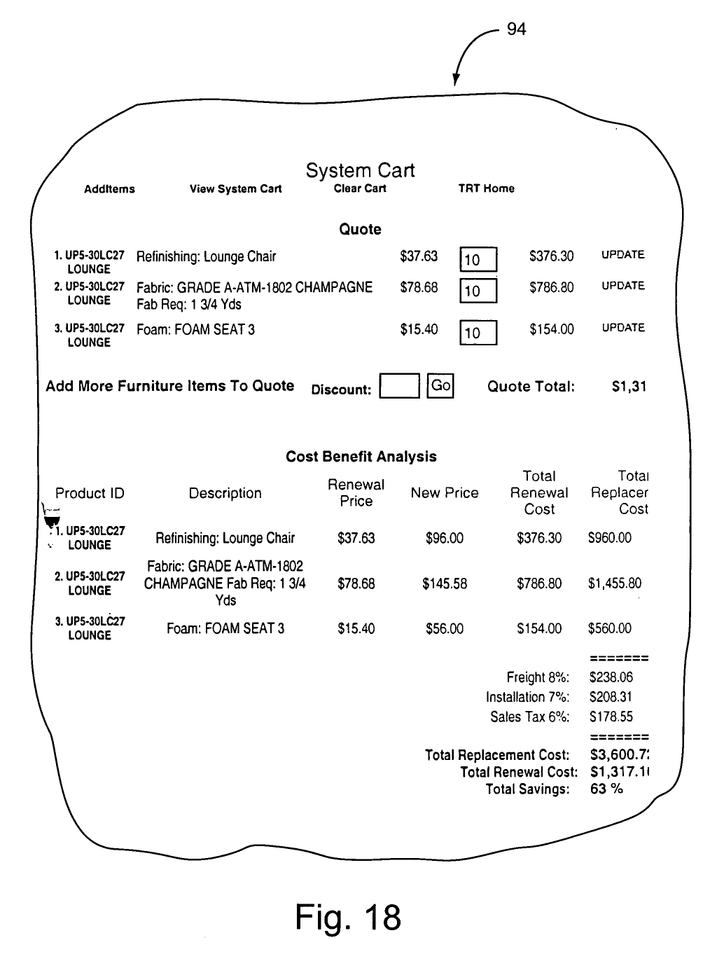

Should the user desire to add foam cushioning underlying the fabric, the user will click on “Choose” in the optional foam pricing chart 88 (corresponding to block 90 in FIG. 2) and the resultant amount will be added to the order total as shown in the screen illustrated in FIG. 17 along with the refinishing and reupholstery estimates. After clicking on “Add To Quote,” the user will be presented with a screen 94 in FIG. 18 summarizing the quote which, in this case, is for the selected lounge chairs. If the desk refinishing example discussed above were part of the same transaction, the screen 94 would indicate the estimated costs for each as well as the total estimated cost.

In addition, the System Cart screen 94 (block 60 in FIG. 2) provides the user with an estimated cost benefit analysis that compares the renewal price per unit with an estimated new price per unit as well as with a total estimated renewal cost as compared to a total estimated replacement cost. After adding in freight installation and sales tax, the user will see the total estimated replacement cost as compared to the total estimated renewal cost and the percent savings realized by choosing renovation as opposed to replacement.

Of course, should the user decide not to continue with the selected activities, he or she can simply click on the “Clear Cart” choice on the horizontal tool bar. The user may also click on “Add Items” if additional items are to be added to the price estimate, or the user can access other areas of the website from the displayed vertical and horizontal menus. It will be understood that the above is but one of many possible examples for renovating various kinds of furniture for a variety of markets.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of generating online a furniture renovation cost estimate for a customer company having an inventory of wood and/or fabric-covered furniture comprising:
(a) establishing a website enabling users to access a data base storing information relating to furniture types, and a range of furniture items within said furniture types;
(b) providing program selection means for enabling users to select a renovation activity for at least one of said furniture items corresponding substantially to a real furniture item of the customer company, and for enabling said users to obtain a cost estimate for said renovation activity.

2. The method of claim 1 wherein the furniture types are classified by business category.

3. The method of claim 1 wherein said program selection means enables users to obtain a comparison between estimated costs for the renovation activity and an alternative replacement activity.

4. The method of claim 1 wherein said range of furniture items includes desks, chairs, sofas, tables, chests, dressers and beds.

5. The method of claim 1 wherein said business categories include ecclesiastical, hospitality and university.

6. The method of claim 1 wherein, during step (a), a user selects a fabric by grade, style and color.

7. The method of claim 1 wherein step (b) includes obtaining cost estimates as a function of the number of items selected for renovation.

8. The method of claim 1 wherein said renovation activity includes at least one of refinishing and reupholstering.

9. The method of claim 1 wherein said renovation activity includes both refinishing and reupholstering.

10. A method of obtaining a cost estimate for furniture renovation online by a user with access to a terminal including a computer, a monitor and a keyboard comprising:
(a) logging on to the website;
(b) choosing a business category that most nearly reflects the user's business;
(c) choosing a furniture item type from among several furniture types;
(d) selecting a volume pricing factor; and
(e) choosing to see a cost estimate quote displayed for selected renovation activity.

11. The method of claim 10 comprising after step (e), choosing to view a system cart displaying a breakdown of said cost estimate.

12. The method of claim 10 wherein said renovation activity comprises refinishing.

13. The method of claim 12 wherein said renovation activity comprises reupholstery.

14. The method of claim 12 and further comprising:
(e)(i) choosing a fabric grade;
(e) (ii) choosing a fabric style within the fabric grade; and
(e)(iii) choosing a fabric color.

15. The method of claim 10 and further comprising, after step (e):
(f) (i) choosing to view a system cart showing a summary of all renovation work requested in the order.

16. The method of claim 10 wherein, in step (e), the user is provided with comparative cost information regarding furniture renovation versus furniture replacement.

17. Apparatus for generating online a furniture renovation cost estimate for a customer having an inventory of wood and/or fabric-covered furniture comprising:
(a) means for establishing a website enabling the customer to access a data base storing information relating to furniture types, a range of furniture items within said furniture types and estimated costs for renovation activities associated with said furniture items; and
(b) means for enabling the customer to select a renovation activity for at least one of said furniture items corresponding substantially to a real furniture item of the customer company, and for enabling the customer to obtain a cost estimate for said renovation activity.

18. Apparatus according to claim 17 wherein the renovation activities include furniture refinishing and furniture reupholstering.

19. Apparatus according to claim 17 and further comprising means for enabling the customer to compare the cost estimate for the renovation activity with a cost estimate for replacing the real furniture item.
